(19) United States
(12) Patent Application Publication
(10) Pub. No.: US 2012/0096194 A1
(43) Pub. Date: Apr. 19, 2012

(54) UNIVERSAL SERIAL BUS DEVICE AND BULK TRANSFER CONTROL CIRCUIT AND CONTROL METHOD THEREOF

(76) Inventors: Yung-Ta CHAN, Hsinchu City (TW); Wei-Cheng Hung, Hsinchu City (TW); Chun-Chi Chu, Hsinchu City (TW); Che-Wei Chang, Hsinchu City (TW); Feng-Ting Jaw, Hsinchu City (TW); Wei-Lu Su, Hsinchu City (TW)

(21) Appl. No.: 12/968,404

(22) Filed: Dec. 15, 2010

(30) Foreign Application Priority Data
Oct. 13, 2010 (TW) 099134933

(51) Int. Cl. G06F 13/10

(52) U.S. Cl. 710/34

(57) ABSTRACT

A bulk transfer control method of a universal serial bus (USB) device includes a timer for counting transmission time of a buck transfer. When the transmission time counted reaches a transmission time setting value, a trigger signal is issued to a transfer end event generator. Then, the transfer end event generator issues a transfer end event signal to a data processing unit so as to end the bulk transfer. Moreover, a USB device and its bulk transfer control circuit are also provided.

### RELATED APPLICATIONS

This application claims priority to Taiwan Application Serial Number 099134933, filed Oct. 13, 2010, which is herein incorporated by reference.

### BACKGROUND

1. Field of Invention

The present invention relates to a universal serial bus (USB) device and a data transfer method thereof, and more particularly to a bulk transfer control circuit and a bulk transfer control method.

2. Description of Related Art

Currently, a USB is a very popular transfer interface in a computer, and many devices connected to the computer may perform data transfer with the computer by using the USB. A USB device can be, for example, an external hard drive, and an Ethernet card with USB interface.

At present, the limit of the bulk transfer data amount each time sent by a USB device is defined by a driver of the USB device.

However, actually, due to the data transfer situation of the USB device, transferred data is often divided into multiple times of bulk transfer, and each time of bulk transfer does not reach a maximum value allowed by the driver. The bulk transfer divided into multiple times of transfer will result in a burden to a computer processor.

Therefore, in order to solve the above problem, it is an important topic regarding how to make the data amount of each time of bulk transfer approximate to a maximum value set by the driver of the USB device, thereby reducing the times of bulk transfer and lowering the burden of the computer processor.

### SUMMARY

Accordingly, an aspect of the present invention is to provide a bulk transfer control circuit for receiving a data packet and sending the data packet in bulk transfer. The bulk transfer control circuit includes a data processing unit, a transfer-end event generator and a timer. The data processing unit ends the bulk transfer according to a transfer-end event signal. The transfer-end event generator issues the transfer-end event signal to the data processing unit according to a trigger signal. The timer counts a transmission time of the bulk transfer, and when the transmission time is counted and reaches a transmission time setting value, the timer issues a trigger signal to the transfer-end event generator. When the data processing unit ends the bulk transfer, the timer is reset.

According to an embodiment of the present invention, the bulk transfer control circuit further includes a data-amount counter for counting a transferred data amount of the bulk transfer. When the transferred data amount is counted and reaches a data-amount setting value, a trigger signal is sent to a transfer-end event generator. When the data processing unit ends the bulk transfer, the data amount counter is reset.

The bulk transfer control circuit further includes an Ethernet packet frame interval timer for counting an Ethernet packet frame interval. When the Ethernet packet frame interval is counted and reaches a predetermined interval setting value and a data buffer does not have data, a trigger signal is sent to a transfer end event generator. When the data processing unit ends the bulk transfer, the Ethernet packet frame interval timer is reset.

An aspect of the present invention is to provide a bulk transfer control method, which includes: counting a transmission time of the bulk transfer when a data packet is fully written into a data buffer on a data packet receiving path; issuing a trigger signal when the transmission time is counted and reaches a transmission time setting value; and finally ending the bulk transfer according to the trigger signal.

According to another embodiment of the present invention, the control method further includes: counting a transferred data amount of the bulk transfer; and when the transferred data amount is counted and reaches a data amount setting value, issuing a trigger signal.

Furthermore, the control method further includes counting the Ethernet packet frame interval; and when the Ethernet packet frame interval is counted and reaches a predetermined interval setting value and nod data exists in the data buffer, issuing a trigger signal.

After the bulk transfer is ended, the transmission time, the transferred data amount, and the Ethernet packet frame interval are reset.

According to yet another embodiment of the present invention, a USB device is provided, which includes an Ethernet port, a USB port, a data buffer, and a bulk transfer control circuit. The data buffer is coupled to the Ethernet port. The bulk transfer control circuit is disposed between the data buffer and the USB port. The bulk transfer control circuit transmits the data packet received by the Ethernet port in a bulk transfer to the USB host device through the USB port.

The bulk transfer control circuit includes a data processing unit, a transfer end event generator, and a timer. The data processing unit ends the bulk transfer according to the transfer end event signal. The transfer end event generator issues a transfer end event signal to a data processing unit according to a trigger signal. The timer counts a transmission time of the bulk transfer, and when the transmission time is counted and reaches a transmission time setting value, the timer issues the trigger signal to the transfer end event generator. When the data packet is fully written into a data buffer, the timer starts counting time. When the data processing unit ends the bulk transfer, the timer is reset.

The bulk transfer circuit in the above embodiments of the present invention includes a timer, a data amount counter, and an Ethernet packet frame interval timer. In this manner, the data amount of the bulk transfer may be controlled to close to the maximum value set by the driver of the USB device, thereby reducing the times of the bulk transfer and decreasing the burden of the computer processor.

### BRIEF DESCRIPTION OF THE DRAWINGS

The present invention can be more fully understood by reading the following detailed description of the embodiments with reference to the accompanying drawings as follows:

FIG. 1 is a schematic view of a USB device according to an embodiment of the present invention;

FIG. 2 is a schematic view of a bulk transfer control circuit according to an embodiment of the present invention; and

FIG. 3 is a flow chart of a bulk transfer control method according to an embodiment of the present invention.

### DETAILED DESCRIPTION

The bulk transfer circuit according to an embodiment of the present invention includes a timer, a data amount counter and an Ethernet packet frame interval timer, for controlling a bulk transfer data amount of the USB device to close to a maximum value set by the driver of the USB device. A USB device in the following embodiments can be an Ethernet card with a USB interface. However, the embodiments of the present invention are not limited thereto, and the parameters of all counters are determined according to the design of practical use and different application scopes.

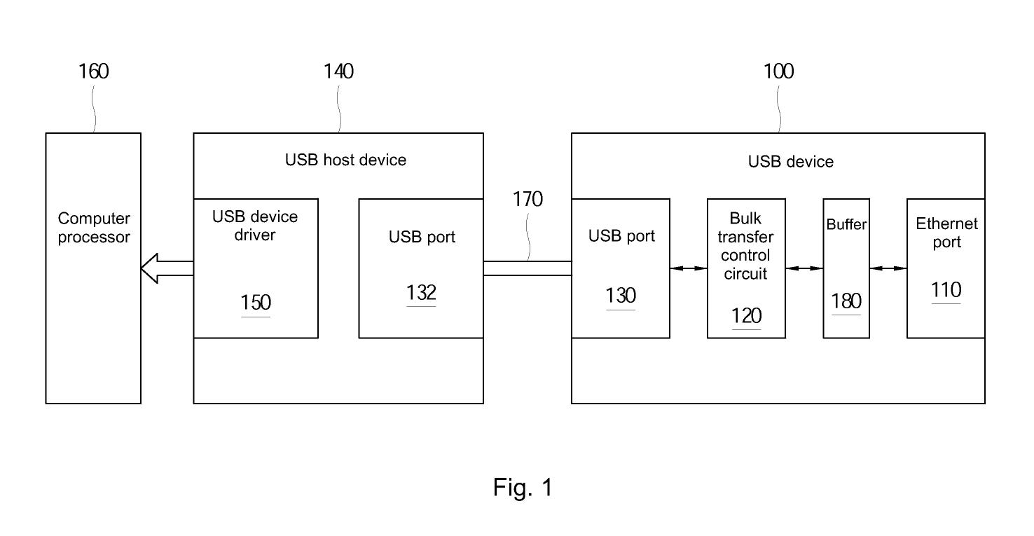

FIG. 1 is a schematic view of a USB device according to an embodiment of the present invention. Referring to FIG. 1, in this embodiment, the USB device 100 is an Ethernet card of the USB interface and is connected to a USB host device 140 through a USB port 130.

It should be noted that every parameter mentioned in the embodiments of the present invention is the reference data obtained under the specification of USB 2.0 and 100 Mbps Ethernet. All the parameters are determined according to the design of practical use and different application scopes.

The USB device 100 includes an Ethernet port 110, a USB port 130, a data buffer 180, and a bulk transfer control circuit 120. The data buffer 180 is coupled to the Ethernet port 110 for registering a data packet received by the Ethernet port 110. The bulk transfer control circuit 120 is disposed between the data buffer 180 and the USB port 130. The bulk transfer control circuit 120 transmits in a bulk transfer the data packet which is received by the Ethernet port 110 and registered in the data buffer 180 to the USB host device 140 through the USB port 130.

The USB port 130 of the USB device 100 is connected to the USB port 132 of the USB host device 140 through a USB cable 170. The bulk transfer data transmitted to the USB host device 140 is then transmitted to a computer processor 160 through a USB device driver 150 so as to be processed.

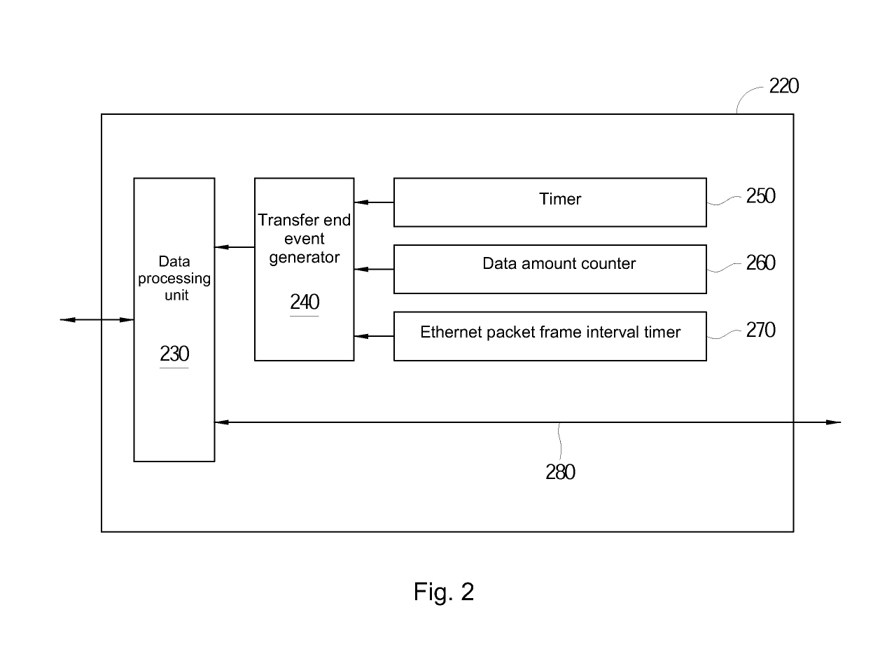

In order to explain in detail the characteristics of the bulk transfer control circuit 120 of the USB device 100 according to the embodiment of the present invention, please refer to FIG. 2 at the same time. FIG. 2 is a schematic view of a bulk transfer control circuit according to an embodiment of the present invention. The bulk transfer circuit 220 has a data processing unit 230, a transfer end event generator 240, a timer 250, a data amount counter 260, and an Ethernet packet frame interval timer 270. The Ethernet data packet 280 is transmitted in a bulk transfer to the USB host device 140 by the data processing unit 230.

Furthermore, the data processing unit 230 ends the bulk transfer according to a transfer end event signal. The transfer end event generator 240 issues the transfer end event signal to the data processing unit 230 according to a trigger signal. The timer 250 counts transmission time of the buck transfer, and when the transmission time is counted and reaches a transmission time setting value, the timer 250 issues the trigger signal to the transfer end event generator 240, so that the transfer end event generator 240 can control the data processing unit 230 to issue a breakpoint to end this bulk transfer. The timer 250 resets the transmission timer when the data processing unit 230 ends the bulk transfer.

When the data packet received by the Ethernet port 110 is fully written into the data buffer 180, the timer 250 starts counting time.

If the USB device driver 150 defines that the data amount of the bulk transfer is limited to 20 Kbytes, in the specification of 100 Mbps Ethernet, the transmission time setting value of the timer 250 is set to 1.62 ms. However, the transmission time setting value may be changed according to the data amount limit of the bulk transfer defined by the USB device driver 150 and other transfer specifications, thereby mainly allowing the data amount sent by the USB device 100 during the transmission time setting value preferably not to exceed the data amount of the bulk transfer defined by the USB device driver 150.

However, the data amount counter 260 counts the data amount received from the Ethernet port 110 and transferred to the USB host device 140. When the data amount counter 260 counts the transferred data amount and the transferred data amount reaches a data amount setting value, the data amount counter 260 issues a trigger signal to the transfer end event generator 240, so that the transfer end event generator 240 can control the data processing unit 230 to issue a breakpoint to end this bulk transfer. When the data processing unit 230 ends the bulk transfer, the data amount counter 260 resets the transferred data amount. In this embodiment, the data amount setting value is set to about 18 Kbytes. However, the data amount setting value may be changed according to the data amount limit of the bulk transfer defined by the USB device driver 150, which preferably does not exceed the data amount limit of the bulk transfer defined by the USB device driver 150.

In some circumstances, the packet transferred from the Ethernet is a small packet at a very long interval, or a communication protocol packet needing replying/receiving by a computer, for example, an Internet Control Message Protocol (ICMP) Ping packet or Echo Reply packet. At this point, the data transferred from the Ethernet are not a section of continuous dense packets, but a string of packets in very low density. In this circumstance, it is desirable for the computer end to process or reply to the received packets as soon as possible. Therefore, the bulk transfer must be ended at an appropriate time, such that the computer end may reduce the waiting time of the bulk transfer in the above circumstance.

To achieve the above objectives, the present invention further includes an Ethernet packet frame interval timer 270. The Ethernet packet frame interval timer 270 counts the Ethernet packet frame interval, and when the Ethernet packet frame interval is counted and reaches a predetermined interval setting value and no data exists in the data buffer 180, the Ethernet packet frame interval timer 270 issues a trigger signal to a transfer end event generator 240, so that the transfer end event generator 240 can control the data processing unit 230 to issue a breakpoint to end this bulk transfer. The Ethernet packet frame interval timer 270 resets when the data processing unit 230 ends the bulk transfer.

The Ethernet packet frame interval timer 270 may detect whether there is data existing in the data buffer 180 at any time. When there is data existing in the data buffer 180, even if the Ethernet packet frame interval exceeds the predetermined interval setting value, the Ethernet packet frame interval timer 270 still does not issue a trigger signal to the end event generator 240. At this point, the data processing unit 230 continuously retrieves data from the data buffer 180 and sends the data to the USB host 140. When there is no data existing in the data buffer 180, the Ethernet packet frame interval timer 270 determines whether a signal needs to be sent to notify the end event producer 240 and further to end this bulk transfer according to whether the packet frame interval of the receiving end of the Ethernet port exceeds the setting value of the Ethernet packet frame interval timer.

Thus, embodiments of the present invention can prevent the data transfer efficiency decrease caused by the circumstance that, the data buffer 180 still has data existing therein, but the bulk transfer is ended as the Ethernet packet frame interval timer 270 counts the Ethernet packet frame interval up to the predetermined interval setting value.

Under the conventional Ethernet specification, the time interval of the Ethernet signal frame is about between 960 nanoseconds (ns) and several microseconds (us) depending on the operation state, and in the embodiment of the present invention, the predetermined interval setting value is set to be in a range from about 2 microseconds to about 32 microseconds. However, the actual predetermined interval setting value is also determined according to the requirements for the system desired by the designer.

The three types of counter disposed in the aforementioned embodiments, including the timer, the data amount counter, and the Ethernet packet frame interval timer, are arranged in an alternate form, i.e. when one of them reaches the predetermined condition, the bulk transfer is controlled to be ended. The designer also may merely select two or one of them for use according to the design conditions, so as to reduce the cost and decrease a circuit size.

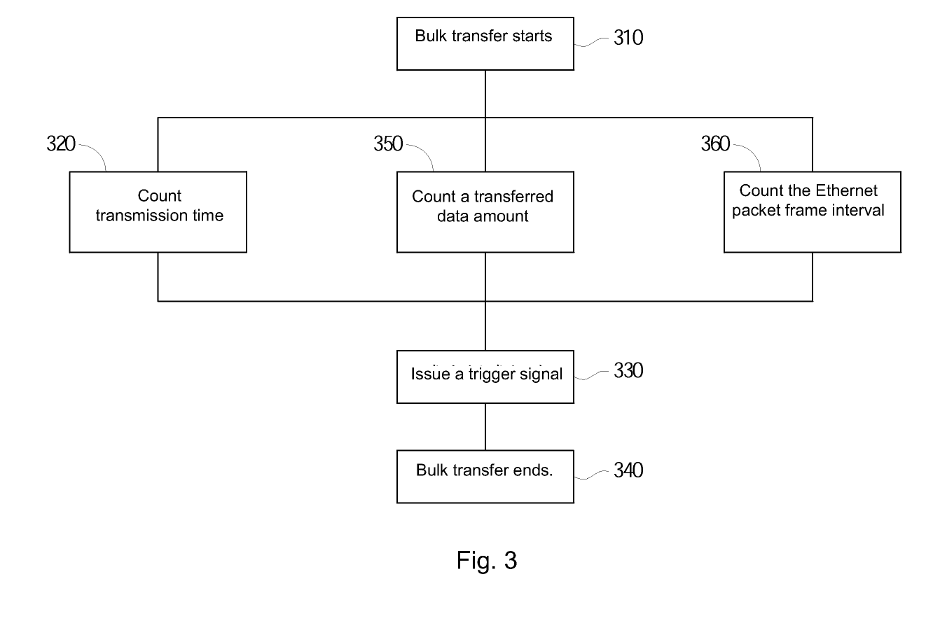

In order to make the bulk transfer control method according to an embodiment of the present invention more apparent, FIG. 3 is a flow chart of a bulk transfer control method. Referring to FIG. 3, in step 310, when the data packet is fully written into the data buffer, the bulk transfer starts. In step 320, transmission time of the bulk transfer is counted. In step 330, when the transmission time is counted and reaches the transmission time setting value, a trigger signal is issued. In step 340, the bulk transfer is ended according to the trigger signal.

Furthermore, the bulk transfer control method further includes counting a transferred data amount of the bulk transfer in step 350, and when the transferred data amount is counted and reaches a data amount setting value, the trigger signal in step 330 is issued.

The bulk transfer control method further includes counting the Ethernet packet frame interval in step 360, and when the Ethernet packet frame interval is counted and reaches the predetermined interval setting value and the data buffer does not have data existing therein, the trigger signal in step 330 is issued.

Among them, steps 320, 350, and 360 are arranged in parallel, wherein, when any one of the three conditions is met first, step 330 is performed to end the bulk transfer.

The bulk transfer circuit according to an embodiment of the present invention includes a timer, a data amount counter, and an Ethernet packet frame interval timer. Thus, the data amount of the bulk transfer may be controlled to close to the maximum value set by the driver of the USB device, thereby reducing the times of bulk transfer and the burden of the computer processor.

It will be apparent to persons skilled in the art that various variations and modifications can be made to the present invention without departing from the scope and spirit of the invention. In view of the foregoing, it is intended that the present invention cover modifications and variations of the present invention provided they fall within the scope of the following claims.

What is claimed is:

1. A bulk transfer control circuit used for receiving a data packet and sending the data packet in a bulk transfer, the bulk transfer control circuit comprising:
a data processing unit used for ending the bulk transfer according to a transfer end event signal;
a transfer end event generator used for issuing the transfer end event signal to the data processing unit according to a trigger signal; and
a timer used for counting a transmission time of the bulk transfer, wherein, when the transmission time is counted and reaches a transmission time setting value, the timer issues the trigger signal to the transfer end event generator;
wherein, when the data processing unit ends the bulk transfer, the timer is reset.

2. The bulk transfer control circuit of claim 1, wherein, when the data packet is fully written into a data buffer located on a data packet receiving path, the timer starts counting time.

3. The bulk transfer control circuit of claim 2, further comprising:
a data amount counter used for counting a transferred data amount of the bulk transfer, wherein, when the transferred data amount is counted and reaches a data amount setting value, the data amount counter issues the trigger signal to the transfer end event generator; and when the data processing unit ends the bulk transfer, the data amount counter is reset.

4. The bulk transfer control circuit of claim 3, further comprising:
an Ethernet packet frame interval timer used for counting an Ethernet packet frame interval, wherein, when the Ethernet packet frame interval is counted and reaches a predetermined interval setting value and no data exists in the data buffer does not have, the Ethernet packet frame interval timer issues the trigger signal to the transfer end event generator; and when the data processing unit ends the bulk transfer, the Ethernet packet frame interval timer is reset.

5. A bulk transfer control method used for receiving a data packet and sending the data packet in a bulk transfer, the bulk transfer control method comprising:
when the data packet is fully written into a data buffer located on a data packet receiving path, counting a transmission time of the bulk transfer;
when the transmission time is counted and reaches a transmission time setting value, issuing a trigger signal; and
ending the bulk transfer according to the trigger signal.

6. The bulk transfer control method of claim 5, further comprising:
counting a transferred data amount of the bulk transfer; and
when the transferred data amount is counted and reaches a data amount setting value, issuing the trigger signal.

7. The bulk transfer control method of claim 6, further comprising:
counting an Ethernet packet frame interval; and
when the Ethernet packet frame interval is counted and reaches a predetermined interval setting value and no data exists in the data buffer, issuing the trigger signal.

8. The bulk transfer control method of claim 7, wherein, after the bulk transfer is ended, the transmission time, the transferred data amount, and the Ethernet packet frame interval are reset.

9. A universal serial bus (USB) device, comprising:
an Ethernet port;
a USB port;
a data buffer coupled to the Ethernet port;
a bulk transfer control circuit disposed between the data buffer and the USB port for transmitting a data packet received by the Ethernet port in a bulk transfer to a USB host device through the USB port, wherein the bulk transfer control circuit comprises:
a data processing unit, used for ending the bulk transfer according to a transfer end event signal;
a transfer end event generator, used for sending the transfer end event signal to the data processing unit according to a trigger signal; and
a timer, used for counting transmission time of the bulk transfer, and when the transmission time is counted and reaches a transmission time setting value, sending the trigger signal to the transfer end event generator;
wherein, when the data packet is fully written into the data buffer, the timer starts counting, and when the data processing unit ends the bulk transfer, the timer is reset.

10. The USB device of claim 9, further comprising:
a data amount counter used for counting a transferred data amount of the bulk transfer, wherein, when the transferred data amount is counted and reaches a data amount setting value, the data amount counter issues the trigger signal to the transfer end event generator; and
an Ethernet packet frame interval timer used for counting an Ethernet packet frame interval, wherein, when the Ethernet packet frame interval is counted and reaches a predetermined interval setting value and no data exists in the data buffer, the Ethernet packet frame interval timer issues the trigger signal to the transfer end event generator; and when the data processing unit ends the bulk transfer, the data amount counter and the Ethernet packet frame interval timer are reset.
